(19) United States
(12) Patent Application Publication
(10) Pub. No.: US 2017/0243065 A1
(43) Pub. Date: Aug. 24, 2017

(54) ELECTRONIC DEVICE AND VIDEO RECORDING METHOD THEREOF

(71) Applicant: SAMSUNG ELECTRONICS CO., LTD., Suwon-si (KR)

(72) Inventor: Jae-Sik SOHN, Suwon-si (KR)

(21) Appl. No.: 15/435,829

(22) Filed: Feb. 17, 2017

(30) Foreign Application Priority Data
Feb. 19, 2016 (KR) 10-2016-0019994

(51) Int. Cl. G06K 9/00; H04N 9/87; G11B 27/28

(52) U.S. Cl. CPC G06K 9/00751; G11B 27/28; H04N 9/8715

(57) ABSTRACT

Disclosed are an electronic device and a video recording method thereof. The electronic device may select multiple first image frames acquired by an image acquisition apparatus during a first time period after a recording start command is input, may select multiple second image frames acquired during a second time period before input of a recording end command corresponding to the recording start command after the first time period, and may generate a video including the selected image frames.

### CROSS-REFERENCE TO RELATED APPLICATION

This application is based on and claims priority under 35 U.S.C. §119 to Korean Application Serial No. 10-2016-0019994, which was filed in the Korean Intellectual Property Office on Feb. 19, 2016, the content of which is incorporated by reference herein in its entirety.

### TECHNICAL FIELD

The present disclosure relates generally to an electronic device and a video recording method thereof.

### BACKGROUND

Various recently-used electronic devices have been developed to include image acquisition apparatuses (e.g., camera modules or image sensors). For example, an electronic device (e.g., a smart phone or a server) can perform a control operation for generating a video by using image frames acquired by an image acquisition apparatus.

The various recently-used electronic devices have been developed to use various functions. The electronic device is provided with a display so as to enable the electronic device to more effectively use various functions. For example, the recent smart phone includes a touch-sensitive display unit (e.g., a touch screen) provided on the front surface thereof.

Also, various applications (e.g., referred to as “Apps”) can be installed and executed in the electronic device. Various input means (e.g., a touch screen, buttons, a mouse, a keyboard, a sensor, etc.) can be used to execute and control the applications in the electronic device.

When a video recording end input is input and then a moving image is generated, an electronic device may set a timestamp for an image frame included in the generated moving image. For example, the electronic device may set a timestamp value or a timestamp interval between image frames and may generate a summarized video including some image frames of the generated moving image.

In order to generate a summarized video, the electronic device needs to process all image frames acquired from a time point of determining a recording start input to a time point of determining a recording end input. Therefore, power may be unnecessarily consumed to process image frames which are not included in the summarized video.

### SUMMARY

An electronic device and video recording method are provided to address the above and other disadvantages of conventional video recording methods.

In accordance with an example aspect of the present disclosure, an electronic device is provided. The electronic device may include an image acquisition apparatus comprising image acquisition circuitry; and a processor, wherein the processor is configured: to determine information related to at least one image frame acquired by the image acquisition circuitry in response to determining a recording start command, to select at least one image frame from the acquired at least one image frame based on the determined information, and in response to determining a recording end command corresponding to the recording start command, to generate a video including the selected at least one image frame.

In accordance with another example aspect of the present disclosure, a video recording method of an electronic device is provided. The video recording method may include determining information related to at least one image frame acquired by image acquisition circuitry in response to determining a recording start command; selecting at least one image frame from the acquired at least one image frame based on the determined information; and in response to determining a recording end command corresponding to the recording start command, generating a video including the selected at least one image frame.

According to various example embodiments of the present disclosure, the electronic device can generate a summarized video using selected image frames selected at predetermined intervals during a time period from a time point of input of a recording start to a time point of input of a recording end. Therefore, even without determining a video including all of the acquired image frames, the electronic device can generate the summarized video by selecting an image frame including a particular importance and by processing only the selected image frame.

### BRIEF DESCRIPTION OF THE DRAWINGS

The above and other aspects, features, and advantages of the present disclosure will be more apparent from the following detailed description, taken in conjunction with the accompanying drawings, in which like reference numerals refer to like elements, and wherein:

FIG. 1 is a block diagram illustrating an example of a configuration of an electronic device according to various example embodiments of the present disclosure;

FIG. 2 is a flowchart illustrating an example of a video recording operation of an electronic device according to various example embodiments of the present disclosure;

FIG. 3A is a flowchart illustrating an example of a video recording operation of an electronic device according to various example embodiments of the present disclosure;

FIG. 3B is a flowchart illustrating an example of a video recording operation of an electronic device according to various example embodiments of the present disclosure;

FIG. 4 is a block diagram illustrating an example of a structure of the selected visual data according to various example embodiments of the present disclosure;

FIG. 5 is a block diagram illustrating an example of a structure of audio data according to various example embodiments of the present disclosure;

FIG. 6 is a diagram illustrating example image data stored in an image buffer according to various example embodiments of the present disclosure;

FIG. 7 is a diagram illustrating an example of a frame selected from among image frames of a video being recorded according to various example embodiments of the present disclosure;

FIG. 8 is a diagram illustrating an example of a frame selected from among image frames of a video being recorded according to various example embodiments of the present disclosure;

FIG. 9 is a block diagram illustrating an example of a network environment according to various example embodiments of the present disclosure;

FIG. 10 is a block diagram illustrating an example of a configuration of an electronic device according to various example embodiments of the present disclosure; and

FIG. 11 is a block diagram illustrating an example of a configuration of a program module according to various example embodiments of the present disclosure.

### DETAILED DESCRIPTION

Hereinafter, various example embodiments of the present disclosure will be described with reference to the accompanying drawings. It should be understood that the example embodiments and the terms used therein are not intended to limit the present disclosure to the particular forms disclosed and the present disclosure is intended to cover various modifications, equivalents, and/or alternatives of the corresponding example embodiments. In describing the drawings, similar reference numerals may be used to designate similar elements. As used herein, the singular forms may include the plural forms as well, unless the context clearly indicates otherwise. In the present disclosure, the expression “A or B” or “at least one of A and/or B” may include all possible combinations of the items listed. The expression “a first,” “a second,” “the first,” or “the second” used in various embodiments of the present disclosure may modify various components regardless of the order and/or the importance but does not limit the corresponding components. When an element (e.g., first element) is referred to as being (operatively or communicatively) “connected,” or “coupled,” to another element (e.g., second element), it may be directly connected or coupled directly to the other element or any other element (e.g., third element) may be interposed between them.

In the present disclosure, the expression “configured to” may be used interchangeably with, for example, “suitable for”, “having the capacity to”, “adapted to”, “made to”, “capable of”, or “designed to” in terms of hardware or software, according to circumstances. In some situations, the expression “device configured to” may refer, for example, to a situation in which the device, together with other devices or components, “is able to”. For example, the phrase “processor adapted (or configured) to perform A, B, and C” may refer, for example, to processing circuitry, such as, for example, and without limitation, a dedicated processor (e.g. embedded processor) only for performing the corresponding operations or a generic-purpose processor (e.g., Central Processing Unit (CPU) or Application Processor (AP)) that can perform the corresponding operations by executing one or more software programs stored in a memory device.

An electronic device according to various example embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a medical device, a camera, and a wearable device, or the like, but is not limited thereto. According to various example embodiments of the present disclosure, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit), or the like, but is not limited thereto. According to some example embodiments of the present disclosure, the electronic device may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a media box (e.g., Samsung HomeSync™, Apple TV™, or Google TV™), a game console (e.g., Xbox™ and PlayStation™), an electronic dictionary, an electronic key, a camcorder, and an electronic photo frame, or the like, but is not limited thereto.

According to another embodiment of the present disclosure, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a vehicle infotainment device, electronic devices for a ship (e.g., a navigation device for a ship, a gyro-compass, etc.), avionics, security devices, an automotive head unit, a robot for home or industry, a drone, an Automatic Teller's Machine (ATM) in banks, Point Of Sales (POS) in a shop, or an Internet of Things device (e.g., a light bulb, various sensors, a sprinkler device, a fire alarm, a thermostat, a streetlamp, a toaster, a sporting goods, a hot water tank, a heater, a boiler, etc.), or the like, but is not limited thereto. According to some example embodiments of the present disclosure, the electronic device may include at least one of a part of a piece of furniture, a building/structure, or a motor vehicle, an electronic board, an electronic signature receiving device, a projector, and various kinds of measuring instruments (e.g., a water meter, an electric meter, a gas meter, and a radio wave meter), or the like, but is not limited thereto. In various example embodiments of the present disclosure, the electronic device may be flexible, or may be a combination of two or more of the aforementioned various devices. The electronic device according to an embodiment of the present disclosure is not limited to the aforementioned devices. In the present disclosure, the term “user” may indicate a person using an electronic device or a device (e.g. an artificial intelligence electronic device) using an electronic device.

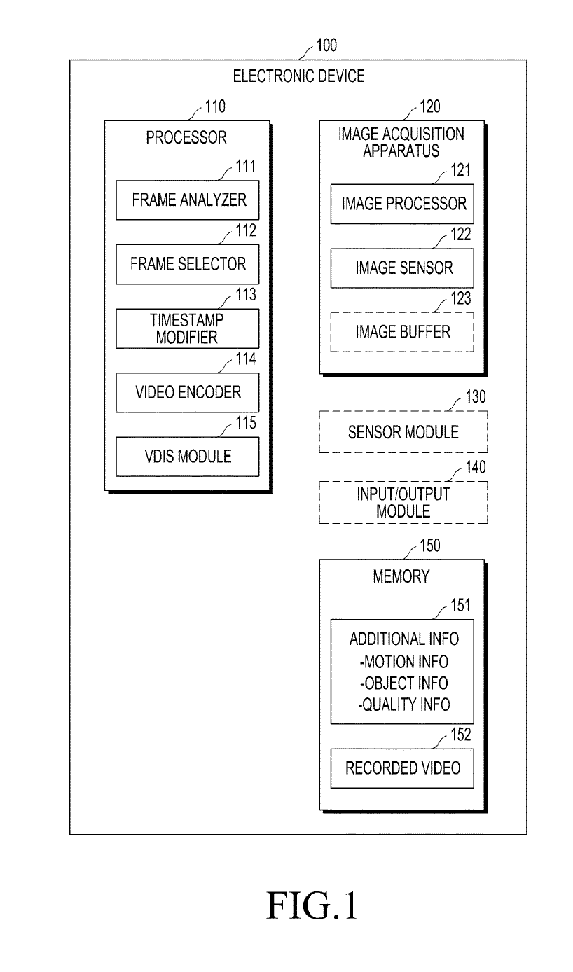

FIG. 1 is a block diagram illustrating an example of a configuration of an electronic device according to various example embodiments of the present disclosure.

Referring to FIG. 1, the electronic device 100 may include at least one of a processor (e.g., including processing circuitry) 110, an image acquisition apparatus (e.g., including image acquisition circuitry) 120, a sensor module 130, an input/output module (e.g., including input/output circuitry) 140, and a memory 150.

The processor 110 may include various modules realized in software, hardware, firmware, or a combination thereof, such as, for example, and without limitation, a frame analyzer 111, a frame selector 112, a timestamp modifier 113, a video encoder 114, and/or a Video Digital Image Stabilization (VDIS) module 115, and may additionally include various elements that analyze a video, which is being recorded, in a unit of a predetermined time period and select an image frame.

The frame analyzer 111 may confirm information (e.g., additional information 151) of each image frame of a video being recorded and may analyze of a particular image frame. For example, the frame analyzer 111 may analyze information of an image frame in a unit of a predetermined time period or in a unit of a predetermined number of frames. The information of the image frame may include at least one piece of information among audio information, motion information, object information, and quality information, and may further include various pieces of information related to an image frame in addition to the at least one piece of information.

According to various example embodiments of the present disclosure, the audio information is information on an audio signal which is input through the input/output module 140, and may include information, such as an audio signal, an audio type (e.g., voice, noise, or music), volume, or the like. The motion information may include information, such as the motion degree, acceleration, location, orientation angle, or the like of the electronic device 100.

According to various example embodiments of the present disclosure, the motion information may be information collected by the sensor module 130. For example, the motion information may be information obtained by analyzing at least one frame in a unit of a predetermined time period or in a unit of a predetermined number of frames. For example, the frame analyzer 111 may confirm a different image between a frame to be analyzed and a previous frame, and thereby may confirm analysis information on the at least one frame. The object information may refer, for example, to information of an object image-captured in each image frame, and may include information, such as the type (e.g., a human being, the sea, or a mountain) of the image-captured object, the face thereof, the size thereof, or the resolution thereof, or the like. The quality information is information on an image frame, and may include at least one piece of information among whether an image frame is filter-processed, resolution, degree of blurring, brightness, white balance, color histogram, exposure, contrast, back light, composition, and the like.

According to various example embodiments of the present disclosure, sensor information is input through the sensor module 130 at an input time point of a particular frame, and may include data representing the motion of the electronic device 100.

According to various example embodiments of the present disclosure, the frame analyzer 111 or the frame selector 112 may analyze the importance of the frame based on, for example, the audio information, the sensor information, the motion information, the object information, and/or the quality information. For example, the frame analyzer 111 may analyze a motion pattern, and may increase the importance when a motion change amount is greater than or is equal to a designated value, or may reduce the importance when the motion change amount is less than the designated value. For example, when the object information includes the face and the face has a preset size or more, the frame analyzer 111 may increase the importance of the frame so as to correspond to a preset value.

According to various example embodiments of the present disclosure, the frame analyzer 111 or the frame selector 112 may analyze the importance of a frame based on a user input. For example, when a user begins to capture an image in a theater, the frame analyzer 111 or the frame selector 112 may increase the importance with respect to a direction that the user has designated. As another example, the frame analyzer 111 or the frame selector 112 may increase the importance with respect to face information that the user has designated.

The frame selector 112 may select at least one image frame from among the recorded image frames according to an importance obtained by analyzing each image frame.

The timestamp modifier 113 may set a timestamp corresponding to time information on a time point of input of an image signal. For example, the processor 110 may include a timestamp in each image frame and may store each image frame including a timestamp.

The timestamp modifier 113 may confirm an image frame for which a timestamp has been set, and may reset the value of the set timestamp based on the importance of a video including the relevant image frame.

According to various example embodiments of the present disclosure, according to the importance of the video or each image frame, the timestamp modifier 113 may increase a reproduction time lapse (or reproduction time interval) between image frames so as to be greater than or equal to a predesignated value, or may reduce the reproduction time lapse so as to be less than the predesignated value. For example, according to the setting of a reproduction time lapse between the selected image frames, some of the selected image frames may be quickly reproduced at hyper-lapses shorter than a preset reproduction time lapse.

The video encoder 114 may convert an image signal into video data having, for example, a standardized format.

The video data may be configured in a unit of image frame, and an image frame may include an image signal which is input at a predetermined time point, sensor data corresponding to each image signal, audio data, or a timestamp.

The VDIS module 115 may correct the motion of an image frame using sensor data which is input through the sensor module 130. According to various example embodiments of the present disclosure, the VDIS module 115 may cut off some of the acquired frames or may change sizes or positions thereof, and thereby may correct the motion of an image frame. For example, when the sensor data represents the direction of motion and represents the rotation of the electronic device 100 by a predetermined angle, the VDIS module 115 may perform a control operation for rotating an image frame, which corresponds to a timestamp of the sensor data, reversely to the rotated angle and correcting the direction of motion.

According to various example embodiments of the present disclosure, the VDIS module 115 may correct the motion of an image frame with reference to at least one previous frame selected by the frame selector 112. For example, the VDIS module 115 may correct the motion of an image frame on the basis of the position of an object commonly appearing in the at least one previous frame and the frame.

The image acquisition apparatus 120 may include various image acquisition circuitry, such as, for example, and without limitation, an image processor 121, an image sensor 122, or an image buffer 123.

According to various example embodiments of the present disclosure, although the image buffer 123 is illustrated as being included in the image acquisition apparatus 120, the image buffer 123 is not limited thereto, and may be configured to be included in the electronic device 100 as an element separate from the image acquisition apparatus 120.

The image processor 121 may include processing circuitry configured to control an overall operation of the image acquisition apparatus 120. For example, the image processor 121 may perform a control operation for processing an image signal, which is input through the image acquisition apparatus 120, and delivering the stored processed image signals to the memory 150 after the processed image signal is stored during a predetermined time period or by a predetermined number of the processed image signals.

According to various example embodiments of the present disclosure, the image processor 121 may perform a control operation for generating an image signal, which is input through the image sensor 122, as an image frame and storing the generated image frame in the image buffer 123.

The image sensor 122 may include various circuitry provided to sense light reflected through an object outside of the electronic device 100, and may convert the sensed light into an electrical image signal.

The image buffer 123 may include various circuitry configured to store a predetermined capacity of image frames. For example, when an image frame is stored in the image buffer 123 during a predetermined time period or by a predetermined number of image frames, the frame analyzer 111 may analyze the at least one image frame included in the image buffer 123. Also, a control operation may be performed for storing at least one image frame, which is selected by the frame selector 112, in the memory 150.

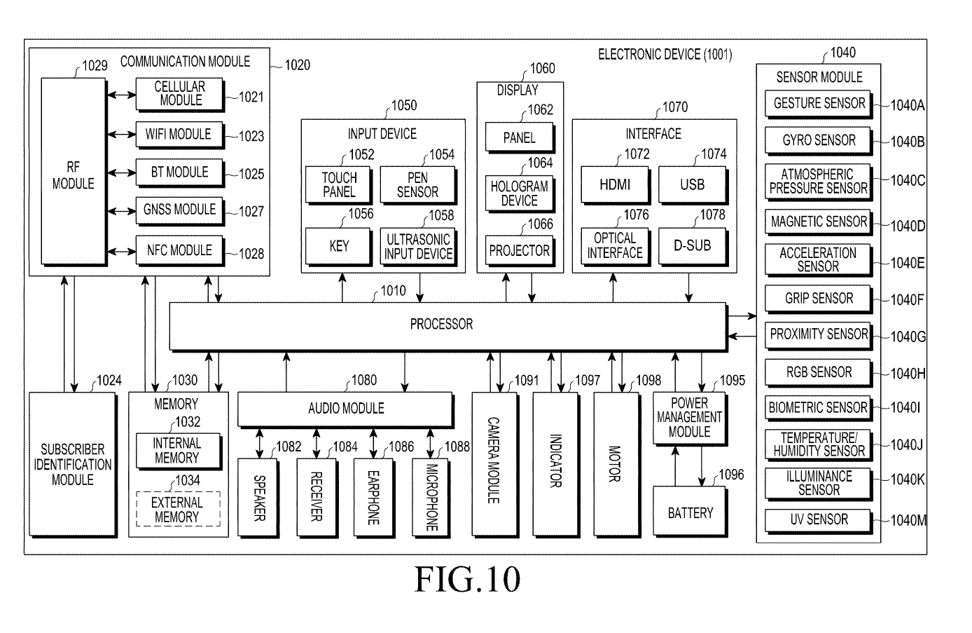

The sensor module 130 (e.g., a sensor module 1040 as illustrated in FIG. 10) may include at least one sensor, and may perform a control operation for generating sensor data sensed through the sensors and respective timestamps of the sensor data.

For example, the at least one sensor may be an accelerometer sensor, a gyroscope sensor, a magnetic sensor, a proximity sensor, a location sensor, and the like, but is not limited thereto, and the sensor module 130 may deliver data measured by each sensor to the processor 110.

For example, the accelerometer sensor may measure data corresponding to the strength of force along each axis or an accelerated impulse along each axis which is exerted along the x, y, and z axes with a reference location of the electronic device 100 as a center.

The gyroscope sensor may measure data corresponding to a measured value (Rad/s) of a rotational velocity (angular velocity) which is exerted along the x, y, and z axes with a reference location of the electronic device 100 as a center.

The proximity sensor may measure whether an object is in close proximity to a particular surface of the electronic device 100, and may measure a distance between the object, which is in close proximity, and the electronic device 100 according to the strength of the measured data.

The location sensor may confirm a signal received from a satellite or a signal (e.g., a beacon) received through short-range communication (e.g., Wi-Fi or BT), and may measure data corresponding to latitude/longitude information, distance, or direction on the basis of the strength of the received signal or time information thereof.

The input/output module 140 may include various input/output circuitry, such as, for example, and without limitation, an audio module (e.g., an audio module 1080). For example, the input/output module 140 may confirm a voice signal measured by the audio module, and may measure data corresponding to a waveform or strength of the confirmed voice signal.

According to various example embodiments of the present disclosure, a signal which is input through the input/output module 140 may be combined with an image signal, and the signal combined with the image signal may be stored in an image frame.

The memory 150 may store recorded video information 151 or a recorded video 152.

The recorded video information 151 may include motion information of an image frame, object information thereof, or quality information thereof. For example, the recorded video information 151 may include information of an image frame in such a manner as to be distinguished from each other for each image frame or for each of image frames acquired during a particular time period.

The recorded video 152 may include an entire video, which includes image frames acquired until a recording start command is confirmed and a recording end command is confirmed, and a summarized video including some image frames selected from the entire video.

According to various example embodiments of the present disclosure, the memory 150 is a non-transitory memory storing instructions that, when executed by at least one processor (e.g., a processor 110), are configured to cause the at least one processor to perform operations comprising: determining information related to at least one image frame acquired by image acquisition circuitry in response to determining a recording start command; selecting at least one image frame from the acquired at least one image frame based on the determined information; and in response to determining a recording end command corresponding to the recording start command, generating a video including the selected at least one image frame.

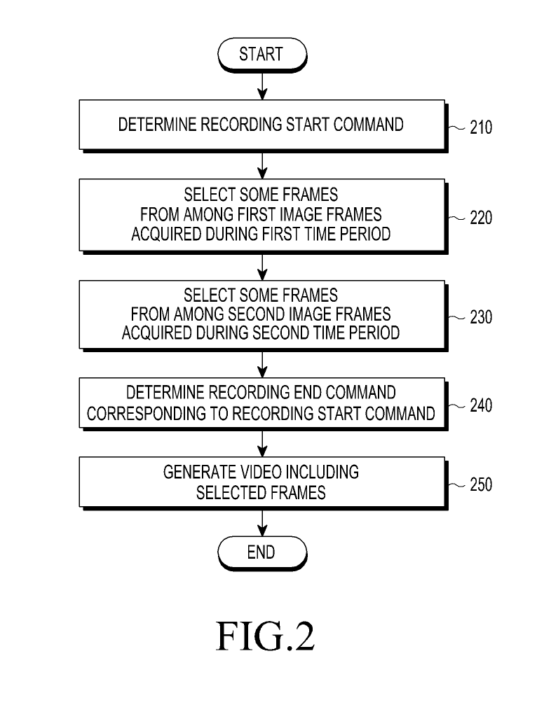

FIG. 2 is a flowchart illustrating an example of a video recording operation of an electronic device according to various example embodiments of the present disclosure.

Referring to FIG. 2, in operation 210, the electronic device may confirm or determine the input of a recording start command.

In operation 220, the electronic device may select some frames from among first image frames acquired during a first time period. For example, the electronic device may determine whether an image frame, which has been analyzed as having an importance greater than or equal to a preset value, is selected from among the first image frames, and may not select an image frame when an importance of the image frame is low.

According to various example embodiments of the present disclosure, when it is determined that, during the first time period, sensor data corresponding to the first image frames is not confirmed or an importance of the first image frame is less than or equal to a predetermined value, the electronic device may perform a control such that some of the image frames acquired during the first time period are not selected.

In operation 230, the electronic device may select some frames from among second image frames acquired during a second time period. For example, the electronic device may determine whether an image frame, which has been analyzed as having an importance greater than or equal to a preset value, is selected from among the second image frames, and may not select an image frame when an importance of the image frame is low.

According to various example embodiments of the present disclosure, when it is determined that, during the second time period, sensor data corresponding to the second image frames is not confirmed or an importance of the second image frame is less than or equal to a predetermined value, the electronic device may perform a control such that some of the image frames acquired during the second time period are not selected.

In operation 240, the electronic device may confirm or determine the input of a recording end command corresponding to the recording start command.

In operation 250, the electronic device may generate a video including some frames selected from among the frames acquired during the first and second time periods. For example, the video including some of the frames corresponds to a result of summarizing an entire video including the image frames acquired until the recording end command is input after the recording start command is input, and may be generated separately from the entire video.

According to various example embodiments of the present disclosure, the electronic device may set an interval between the frames included in the generated video. For example, the electronic device may analyze each selected image frame, may again determine an importance of the relevant image frame, and may set an interval between the relevant image frame and a previous image frame.

According to various example embodiments of the present disclosure, the previous image frame may be an image frame which has been last acquired before a particular image frame is acquired, and may additionally include at least one image frame including a timestamp value less than a timestamp value of the particular image frame.

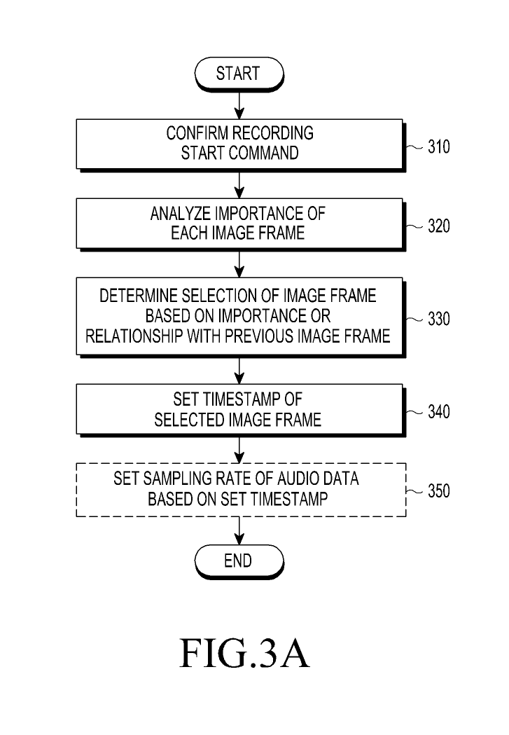

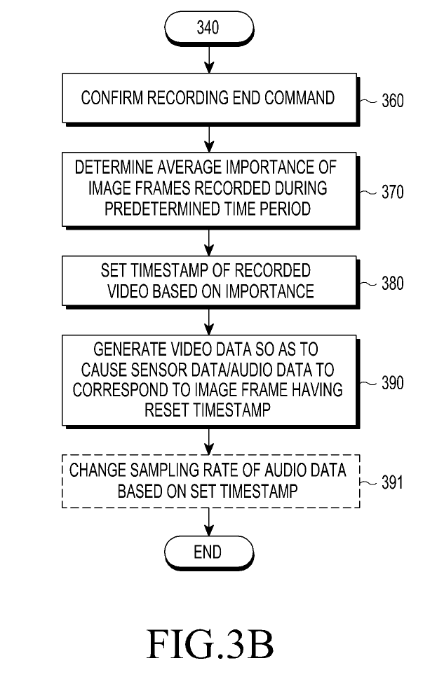

FIG. 3A is a flowchart illustrating an example of a video recording operation of an electronic device according to various example embodiments of the present disclosure.

Referring to FIG. 3A, in operation 310, the electronic device may confirm the start of video recording.

In operation 320, the electronic device may analyze an importance of each image frame being recorded. For example, the electronic device may determine the importance of each image frame based on information included in each image frame.

In operation 330, the electronic device may determine the selection of at least one image frame from among the recorded image frames based on the analyzed importance or a relationship with at least one previous image frame. For example, the electronic device may select an image frame, which includes an importance greater than or equal to a predetermined value, from among the recorded image frames.

According to various example embodiments of the present disclosure, the electronic device may reset a frame selection interval to be less than or equal to a set value when it is determined that the image frame, which includes the importance greater than or equal to the predetermined value, is acquired by a designated number or more of image frames during a predetermined time period or has a relationship with the previous image frame. For example, when it is preset that one image frame per five image frames is selected, the electronic device may set the selection of one image frame from among three image frames with respect to image frames each including an importance greater than or equal to the predetermined value.

According to various example embodiments of the present disclosure, the electronic device may determine a relationship with the previous image frames with respect to the image frames which have been acquired during the predetermined time period and each include an importance greater than or equal to the predetermined value. For example, the electronic device may determine that particular image frames (e.g., frames acquired during a second time period) have a relationship with previous image frames (e.g., frames acquired during a first time period), when the particular image frames and the previous image frames include data (e.g., sensor data) of types or data information (e.g., motion information or object information) which correspond to the particular image frames and the previous image frames.

In operation 340, the electronic device may set a timestamp of the selected image frame.

In operation 350, the electronic device may set a sampling rate of audio data based on the set timestamp. For example, operation 350 described above may be omitted when the electronic device does not confirm audio data corresponding to the selected image frame, or according to the importance of an image frame.

According to various example embodiments of the present disclosure, the electronic device may set a sampling rate based on the importance of an image frame, and may set additional information (e.g., volume information) of the sampled audio data based on the set sampling rate. For example, the electronic device may adjust a volume value of audio data, which corresponds to a particular image frame, to be high or low according to the importance of the relevant image frame.

According to various example embodiments of the present disclosure, the electronic device may sample the audio data in response to a selection cycle of the selected image frame. For example, when a first image frame which is acquired tenth and a second image frame which is acquired twentieth are selected from a video having a reproduction speed of 30 frames per second (fps), the electronic device may set a timestamp interval between the first and second image frames from 10 to 1, and may set a sampling rate value from the previous value to a value 10 times less than the previous value.

FIG. 3B is a flowchart illustrating an example of a video recording operation of an electronic device according to various example embodiments of the present disclosure (e.g., the generation of a video including the selected some frames in operation 250 of FIG. 2).

Referring to FIG. 3B, in operation 360, the electronic device may confirm the input of a recording end command.

In operation 370, the electronic device may determine an average importance of image frames recorded during a predetermined time period. For example, the average importance may be determined as an average of importances (e.g., importance values) of the respective image frames, or may be determined based on an average value of sensor data on the recorded image frames, quality information of the recorded image frames, or information of audio data of the recorded image frames.

In operation 380, the electronic device may set a timestamp based on the importance of a recorded image.

In operation 390, the electronic device may generate video data so as to cause sensor data or audio data to correspond to an image frame having a reset timestamp.

In operation 391, the electronic device may change a sampling rate of the audio data on the basis of the set timestamp. For example, the electronic device may change the value of the sampling rate, which has been set in operation 350 described above, on the basis of the timestamp which has been set in operation 380 described above.

According to various example embodiments of the present disclosure, operation 391 described above may be omitted when the electronic device does not confirm audio data corresponding to the selected image frame or the audio data of which the sampling rate has been set, or based on the importance.

According to various example embodiments of the present disclosure, the electronic device may adjust a volume of the audio data, which corresponds to the selected image frame, according to the importance of the relevant selected image frame.

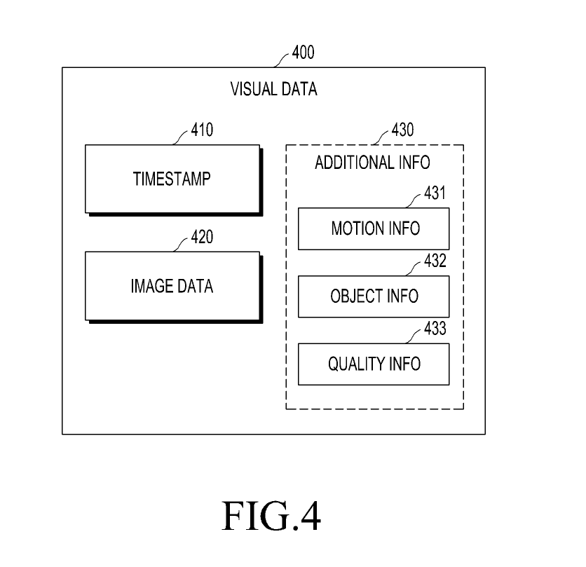

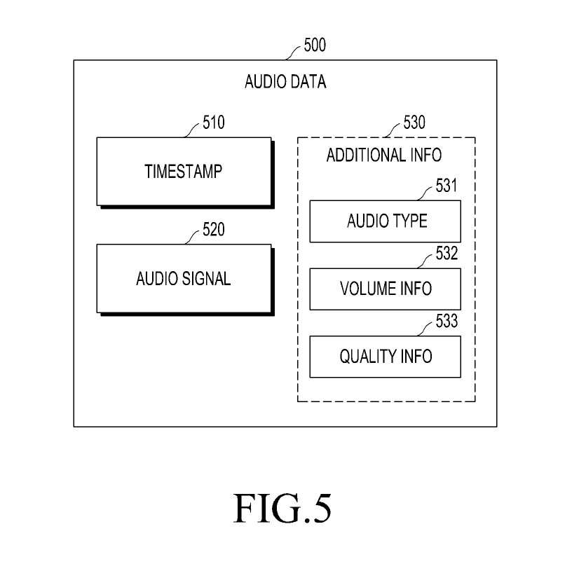

FIGS. 4 and 5 below illustrate various examples of structures of video data according to various example embodiments of the present disclosure.

According to various example embodiments of the present disclosure, the video data may be configured as one file including visual data 400 and audio data 500, and may be generated or converted according to various formats (e.g., mpeg, mp4 (mpeg-4), mov, avi, wmv, asx, swf, skm, svi, dat, vob, etc.).

According to various example embodiments of the present disclosure, the visual data may be stored as a file separate from the audio data. For example, the processor 110 may perform a control operation for simultaneously reproducing the visual data file and audio data file, which are separately stored, through a media player 1182.

FIG. 4 is a block diagram illustrating an example of a structure of the selected visual data according to various example embodiments of the present disclosure.

Referring to FIG. 4, the visual data 400 may include a timestamp 410, image data 420, and/or additional information 430.

The timestamp 410 may refer, for example, to time information for identifying the visual data 400, and may represent reference time information. For example, the value of the timestamp 410 may be reset based on the adjustment of an interval between timestamps corresponding to at least one image datum in a video including the visual data 400. According to an example embodiment of the present disclosure, when the timestamp 410 does not exist, the image data may be reproduced based on a preset frame rate.

The image data 420 may refer, for example, to sensor data sensed by the image sensor 122, and may be an electrical signal into which light which has been input from the outside is converted. For example, the image data 420 may be stored in a unit of image frame.

The additional information (or metadata) 430 may, for example, be related to the image data 420, and may include motion information 431, object information 432, or quality information 433. For example, the additional information 430 may be generated based on sensor data sensed by an electronic device (e.g., the electronic device 100), or may include information of image data analyzed by a processor that senses the image data 420.

The motion information 431 may refer, for example, to movement information of the visual data 400, and may be generated through a sensor (e.g., the sensor module 130) at a time point corresponding to the timestamp 410, or may include the value of the sensed sensor data. According to an example embodiment of the present disclosure, the motion information may be determined based on a variation between the image frames.

The object information 432 may refer, for example, to information on an image-captured object of the visual data 400, and may include information, such as identification information of an object, the size thereof, an image-capturing resolution thereof, or the like.

The quality information 433 may, for example, represent a state of image-capturing of the image data 420, and may include noise, whether blurring is processed, image filter information, resolution, or the like.

According to various example embodiments of the present disclosure, a part of the additional information 430 may be changed or omitted according to the elements of the electronic device (e.g., the electronic device 100).

FIG. 5 is a block diagram illustrating an example of a structure of audio data according to various example embodiments of the present disclosure.

Referring to FIG. 5, the audio data 500 may include a timestamp 510, an audio signal 520, and/or additional information 530.

The timestamp 510 may refer, for example, to time information for identifying the audio data 500, and may represent a time point of input of the audio signal 520 or a time point of reproduction thereof in a video.

The audio signal 520 may include, for example, data measured by an input/output module (e.g., an audio module).

The additional information 530 may, for example, be related to the audio signal 520, and may include an audio type 531, volume information 532, and/or quality information 533.

The audio type 531 may, for example, be used to classify the audio signal 520, and may represent whether a particular audio signal corresponds to a human voice, noise, music, or the like.

The volume information 532 may include, for example, a volume value of the audio signal 520 based on an average volume of an audio signal which is input during a predetermined time period.

The quality information 533 may, for example, represent a state of input of the audio signal 520, and may include a waveform or strength value of the audio signal 520.

According to various example embodiments of the present disclosure, according to the performance of the audio module (e.g., the audio module 1080) of the electronic device (e.g., the electronic device 100), the additional information 530 may further include various pieces of information related to the audio signal 520, or a part of the additional information 530 may be changed or omitted.

According to various example embodiments of the present disclosure, the electronic device may confirm an interval of selection of each image frame in the visual data 400 acquired to correspond to the audio data 500, and may set a sampling rate for sampling the audio signal 520 from the audio data 500 on the basis of the interval.

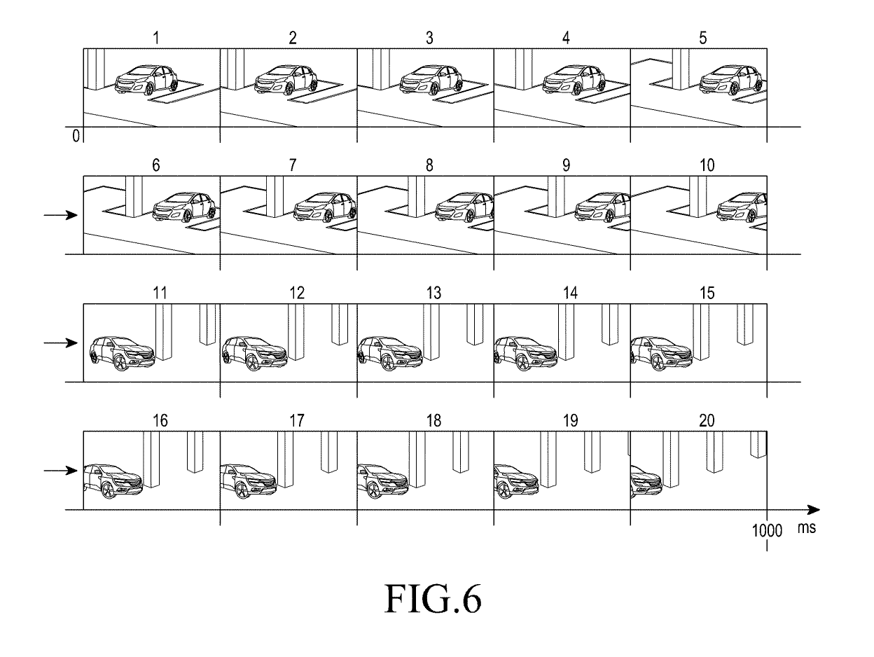

FIG. 6 is a diagram illustrating example image data stored in an image buffer (e.g., the image buffer 123) according to various example embodiments of the present disclosure.

Referring to FIG. 6, according to various example embodiments of the present disclosure, the electronic device may confirm image frames acquired during a first time period (e.g., 0 to 1 seconds) based on the input of a recording start command. For example, the electronic device may acquire 20 image frames in a unit of 50 ms during the first time period.

According to various example embodiments of the present disclosure, the electronic device may determine an importance of each of the acquired image frames before a recording end command corresponding to the recording start command is input after the recording start command is input.

According to various example embodiments of the present disclosure, the electronic device may select some of the image frames acquired during a predetermined time period according to the determined importance values, and may generate a video including the selected image frames based on the input of the recording end command.

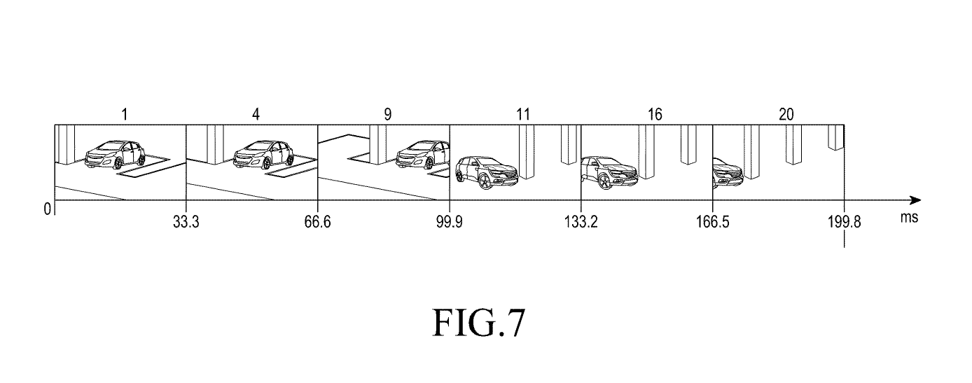

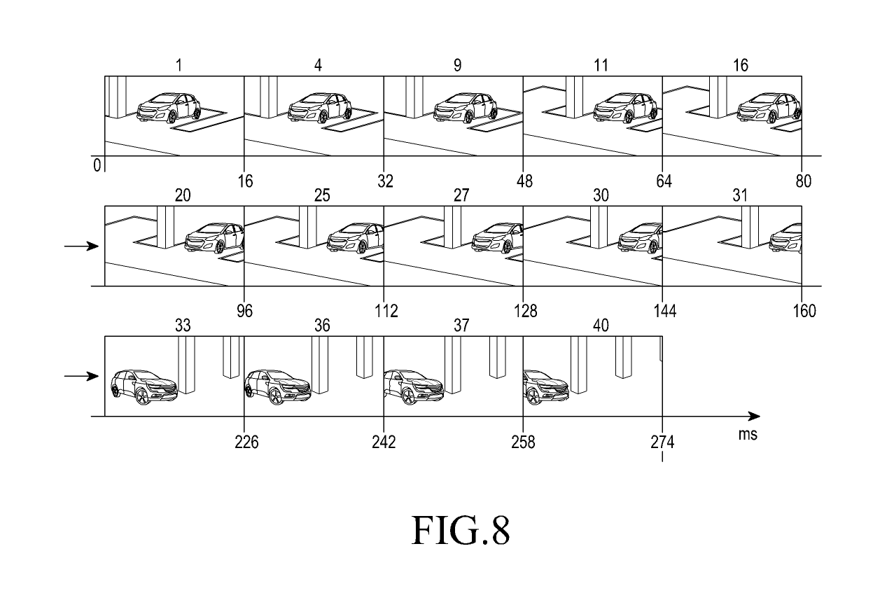

Hereinafter, referring to FIGS. 7 and 8, an operation of selecting some of the image frames and setting a timestamp between the image frames will be described.

FIG. 7 is a diagram illustrating an example of a frame selected from among image frames of a video being recorded according to various example embodiments of the present disclosure.

Referring to FIG. 7, the electronic device may determine importance values of respective image frames acquired during a first time period after a recording start command is input, and may select at least one image frame. For example, the importance may be determined based on information of the image frame or information of audio data corresponding to the image frame.

According to various example embodiments of the present disclosure, the electronic device may select an image frame at a first time point before a recording end command is input after the recording start command is input.

According to various example embodiments of the present disclosure, image frames may be classified based on importance values corresponding to various values (e.g., one of 1 to 10) according to the capacity of the image buffer or the reproduction length of a video intended to be generated.

According to various example embodiments of the present disclosure, as some of the image frames acquired during the first time period, a first image frame, a fourth image frame, a ninth image frame, an eleventh image frame, a sixteenth image frame, and a twentieth image frame may be selected. For example, the selected image frames may be selected because an importance is determined to be greater than or equal to 7.

The first image frame may have an importance determined to be 10 because location data sensed at a time point corresponding to a timestamp of the first image frame represents a predesignated location (e.g., a parking lot).

The fourth image frame may have an importance determined to be 8 because audio data which is input at a time point corresponding to a timestamp of the fourth image frame is classified as belonging to a particular type (e.g., human voice).

The ninth image frame and the sixteenth image frame may have an importance determined to be 7 because a value corresponding to a resolution in quality information of each image signal is measured to be greater than or equal to a predesignated value.

The eleventh image frame may have an importance determined to be 8 because sensor data having a direction change at a time point corresponding to a timestamp of the eleventh image frame is measured to be greater than or equal to a predetermined value.

The twentieth image frame may have an importance determined to be 7 because sensor data is measured which has a motion greater than or equal to a predetermined value at a time point corresponding to a timestamp of the twentieth image frame.

According to various example embodiments of the present disclosure, the generated video may sequentially include the first image frame, the fourth image frame, the ninth image frame, the eleventh image frame, the sixteenth image frame, and the twentieth image frame in descending order of the timestamp values of the respective image frames.

According to various example embodiments of the present disclosure, the electronic device may determine an importance of the generated video, and may set, to a predetermined value (e.g., 33.3 ms), a timestamp interval between image frames on the basis of the determined importance. For example, when a reproduction start command for reproducing the generated video is input, the generated video may be reproduced in a unit of 30 fps.

FIG. 8 is a diagram illustrating an example of a frame selected from among image frames of a video being recorded according to various example embodiments of the present disclosure.

Referring to FIG. 8, the electronic device may confirm image frames selected during a first time period (e.g., 0 to 1 seconds) and a second time period (e.g., 1 to 2 seconds) after the electronic device confirms (e.g., operation 210) the input of a recording start command, and may generate a video using the selected image frames. For example, the electronic device may acquire first to twentieth image frames during the first time period, and may acquire 21st to 40th image frames during the second time period.

According to various example embodiments of the present disclosure, the electronic device may analyze the image frames acquired during the first time period, may determine importance values of the respective image frames, and may select image frames (e.g., the first, fourth, ninth, eleventh, sixteenth, and twentieth image frames) including importance values greater than or equal to a designated value.

According to various example embodiments of the present disclosure, the electronic device may analyze the image frames acquired during the second time period, and may select image frames (e.g., the 25th, 27th, 30th, 31st, 33rd, 36th, 37th, and 40th image frames) including importance values greater than or equal to the designated value.

According to various example embodiments of the present disclosure, when the electronic device confirms (e.g., operation 240) the input of a recording end command corresponding to the recording start command, the electronic device may set an interval of a timestamp value between the previous image frames and the respective selected image frames based on the importance values of the respective selected image frames.

According to various example embodiments of the present disclosure, the electronic device may set a timestamp interval between the image frames to 66.6 ms when an importance is determined to be greater than or equal to a preset value (e.g., 5), or may set the timestamp interval to 16.6667 ms when the importance is determined to be less than the preset value. For example, the 31st image frame may have a timestamp interval, which is set from existing 50 ms to an increased value, when the value of sensor data corresponding to a timestamp of the 31st image frame is sensed to be greater than or equal to a predetermined value.

According to various example embodiments of the present disclosure, when a reproduction start command is input, the electronic device may reproduce the selected image frames at the set timestamp intervals. For example, each of the first image frame, fourth image frame, ninth image frame, eleventh image frame, sixteenth image frame, twentieth image frame, 25th image frame, 27th image frame, 30th image frame, 33rd image frame, 36th image frame, 37th image frame, and 40th image frame may be reproduced at intervals of 16.6667 ms between the previous image frames and the respective image frames, and the 31st image frame may be reproduced at an interval of 66.6 ms between the previous 30th image frame and the 31st image frame.

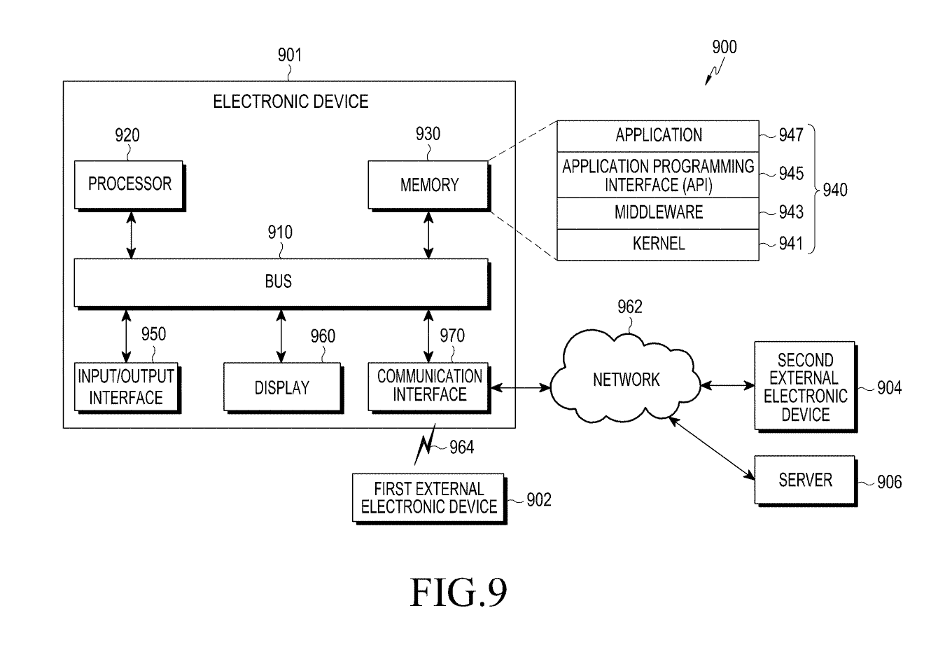

FIG. 9 is a block diagram illustrating an example of a network environment according to various example embodiments of the present disclosure.

Referring to FIG. 9, an electronic device 901 may be included in the network environment 900. The electronic device 901 may include a bus 910, a processor (e.g., including processing circuitry) 920, a memory 930, an input/output interface (e.g., including input/output circuitry) 950, a display 960, and a communication interface (e.g., including interface circuitry 970. In some example embodiments of the present disclosure, at least one of the above elements of the electronic device 901 may be omitted from the electronic device 901, or the electronic device 901 may additionally include other elements. The bus 910 may include a circuit that interconnects the elements 910 to 970 and delivers a communication (e.g., a control message or data) between the elements 910 to 970. The processor 920 may include various processing circuitry, such as, for example, and without limitation, one or more of a CPU, an AP, and a Communication Processor (CP). The processor 920 may perform, for example, calculations or data processing related to control over and/or communication by at least one of the other elements of the electronic device 901.

The memory 930 may include a volatile memory and/or a non-volatile memory. The memory 930 may store, for example, commands or data related to at least one of the other elements of the electronic device 901. According to an example embodiment of the present disclosure, the memory 930 may store software and/or a program 940. The program 940 may include, for example, a kernel 941, middleware 943, an Application Programming Interface (API) 945, and/or an application program (or an application) 947. At least some of the kernel 941, the middleware 943, and the API 945 may be referred to as an “Operating System (OS).” For example, the kernel 941 may control or manage system resources (e.g., the bus 910, the processor 920, the memory 930, and the like) used to execute operations or functions implemented by the other programs (e.g., the middleware 943, the API 945, and the application program 947). Also, the kernel 941 may provide an interface capable of controlling or managing the system resources by accessing the individual elements of the electronic device 901 by using the middleware 943, the API 945, or the application program 947.

For example, the middleware 943 may serve as an intermediary that enables the API 945 or the application program 947 to communicate with the kernel 941 and to exchange data therewith. Also, the middleware 943 may process one or more task requests received from the application program 947 according to a priority. For example, the middleware 943 may assign a priority, which enables the use of system resources (e.g., the bus 910, the processor 920, the memory 930, etc.) of the electronic device 901, to at least one of the application programs 947, and may process the one or more task requests. The API 945 is an interface through which the application 947 controls a function provided by the kernel 941 or the middleware 943, and may include, for example, at least one interface or function (e.g., command) for file control, window control, image processing, character control, or the like. For example, the input/output interface 950 may deliver a command or data, which is input from a user or another external device, to the element(s) other than the input/output interface 950 within the electronic device 901, or may output, to the user or another external device, commands or data received from the element(s) other than the input/output interface 950 within the electronic device 901.

Examples of the display 960 may include a Liquid Crystal Display (LCD), a Light-Emitting Diode (LED) display, an Organic Light-Emitting Diode (OLED) display, a MicroElectroMechanical Systems (MEMS) display, and an electronic paper display, or the like, but is not limited thereto. For example, the display 960 may display various pieces of content (e.g., text, images, videos, icons, symbols, and/or the like.) to the user. The display 960 may include a touch screen, and may receive, for example, a touch input, a gesture input, a proximity input, or a hovering input provided by an electronic pen or a body part of the user. The communication interface 970 may include various communication circuitry configured to establish, for example, communication between the electronic device 901 and an external device (e.g., a first external electronic device 902, a second external electronic device 904, or a server 906). For example, the communication interface 970 may be connected to a network 962 through wireless or wired communication and may communicate with the external device (e.g., the second external electronic device 904 or the server 906).

The wireless communication may include, for example, a cellular communication protocol which uses at least one of Long-Term Evolution (LTE), LTE-Advanced (LTE-A), Code Division Multiple Access (CDMA), Wideband CDMA (WCDMA), Universal Mobile Telecommunications System (UNITS), WiBro (Wireless Broadband), and Global System for Mobile Communications (GSM). According to an embodiment of the present disclosure, the wireless communication may include at least one of, for example, WiFi, Bluetooth, Bluetooth Low Energy (BLE), Zigbee, Near Field Communication (NFC), magnetic secure transmission, Radio Frequency (RF), and Body Area Network (BAN) that may be used in short range wireless communication 964 with, for example, the first external electronic device 902. According to an embodiment of the present disclosure, the wireless communication may include GNSS. The GNSS may be, for example, a Global Positioning System (GPS), a Global Navigation Satellite System (Glonass), a Beidou Navigation Satellite System (hereinafter “Beidou”), or a European Global Satellite-based Navigation System (Galileo). Hereinafter, in the present disclosure, the term “GPS” may be used interchangeably with the term “GNSS.” The wired communication may be performed by using at least one of, for example, a Universal Serial Bus (USB), a High Definition Multimedia Interface (HDMI), Recommended Standard 232 (RS-232), Power Line communication (PLC), and a Plain Old Telephone Service (POTS). The network 962 may include at least one of communication networks, such as a computer network (e.g., a Local Area Network (LAN), or a Wide Area Network (WAN)), the Internet, and a telephone network.

Each of the first and second external electronic devices 902 and 904 may be of a type identical to or different from that of the electronic device 901. According to various embodiments of the present disclosure, all or some of operations performed by the electronic device 901 may be performed by another electronic device or multiple electronic devices (e.g., the first and second external electronic devices 902 and 904 or the server 906). According to an embodiment of the present disclosure, when the electronic device 901 needs to perform some functions or services automatically or by a request, the electronic device 901 may send, to another device (e.g., the first external electronic device 902, the second external electronic device 904, or the server 906), a request for performing at least some functions related to the functions or services, instead of performing the functions or services by itself, or additionally. Another electronic device (e.g., the first external electronic device 902, the second external electronic device 904, or the server 906) may execute the requested functions or the additional functions, and may deliver a result of the execution to the electronic device 901. The electronic device 901 may process the received result without any change or additionally and may provide the requested functions or services. To this end, use may be made of, for example, cloud computing technology, distributed computing technology, or client-server computing technology.

FIG. 10 is a block diagram illustrating an example of a configuration of an electronic device according to various example embodiments of the present disclosure.

Referring to FIG. 10, the electronic device 1001 may include the whole or part of the electronic device 901 illustrated in FIG. 9. The electronic device 1001 may include at least one processor (e.g., an AP) (e.g., including processing circuitry) 1010, a communication module (e.g., including communication circuitry) 1020, a subscriber identification module 1024, a memory 1030, a sensor module 1040, an input apparatus (e.g., including input circuitry) 1050, a display 1060, an interface (e.g., including interface circuitry 1070, an audio module 1080, a camera module 1091, a power management module 1095, a battery 1096, an indicator 1097, and a motor 1098. The processor 1010 may include various processing circuitry configured to control multiple hardware or software elements connected to the processor 1010 by running, for example, an OS or an application program, and may perform the processing of and arithmetic operations on various data. The processor 1010 may be implemented by, for example, various processing circuitry that may be implemented as a System on Chip (SoC). According to an embodiment of the present disclosure, the processor 1010 may further include a Graphic Processing Unit (GPU) and/or an image signal processor. The processor 1010 may include at least some (e.g., a cellular module 1021) of the elements illustrated in FIG. 10. The processor 1010 may load, into a volatile memory, instructions or data received from at least one (e.g., a non-volatile memory) of the other elements and may process the loaded instructions or data, and may store the resulting data in a non-volatile memory.

The communication module 1020 may have a configuration identical or similar to that of the communication interface 970. The communication module 1020 may include various communication circuitry, such as, for example, and without limitation, the cellular module 1021, a Wi-Fi module 1023, a Bluetooth (BT) module 1025, a GNSS module 1027, an NFC module 1028, and an RF module 1029. For example, the cellular module 1021 may provide a voice call, a video call, a text message service, an Internet service, and the like through a communication network. According to an embodiment of the present disclosure, the cellular module 1021 may identify or authenticate an electronic device 1001 in the communication network by using the subscriber identification module (e.g., a Subscriber Identity Module (SIM) card) 1024. According to an embodiment of the present disclosure, the cellular module 1021 may perform at least some of the functions that the processor 1010 may provide. According to an embodiment of the present disclosure, the cellular module 1021 may include a CP. According to some embodiments of the present disclosure, at least some (e.g., two or more) of the cellular module 1021, the Wi-Fi module 1023, the BT module 1025, the GNSS module 1027, and the NFC module 1028 may be included in one Integrated Chip (IC) or IC package. The RF module 1029 may transmit and receive, for example, communication signals (e.g., RF signals). The RF module 1029 may include, for example, a transceiver, a Power Amplifier Module (PAM), a frequency filter, a Low Noise Amplifier (LNA), and an antenna. According to another embodiment of the present disclosure, at least one of the cellular module 1021, the Wi-Fi module 1023, the BT module 1025, the GNSS module 1027, and the NFC module 1028 may transmit and receive RF signals through a separate RF module. The subscriber identification module 1024 may include, for example, a card including a subscriber identity module or an embedded SIM, and may contain unique identification information (e.g., an Integrated Circuit Card Identifier (ICCID)) or subscriber information (e.g., an International Mobile Subscriber Identity (IMSI)).

The memory 1030 (e.g., the memory 930) may include, for example, an internal memory 1032 and/or an external memory 1034. The internal memory 1032 may include at least one of, for example, a volatile memory (e.g., a Dynamic Random Access Memory (DRAM), a Static RAM (SRAM), a Synchronous DRAM (SDRAM), etc.); and a non-volatile memory (e.g., a One Time Programmable Read-Only Memory (OTPROM), a Programmable ROM (PROM), an Erasable and Programmable ROM (EPROM), an Electrically Erasable and Programmable ROM (EEPROM), a mask ROM, a flash ROM, a flash memory, a hard drive, and a Solid State Drive (SSD)). The external memory 1034 may include a flash drive, for example, a Compact Flash (CF), a Secure Digital (SD), a Micro-Secure Digital (Micro-SD), a Mini-Secure Digital (Mini-SD), an extreme Digital (xD), a Multi-Media Card (MMC), a memory stick, or the like. The external memory 1034 may be functionally or physically connected to the electronic device 1001 through various interfaces.

For example, the sensor module 1040 (e.g., the sensor module 130) may measure a physical quantity or may detect an operation state of the electronic device 1001, and may convert the measured physical quantity or the detected operation state into an electrical signal. The sensor module 1040 may include at least one of, for example, a gesture sensor 1040A, a gyro sensor 1040B, an atmospheric pressure sensor 1040C, a magnetic sensor 1040D, an acceleration sensor 1040E, a grip sensor 1040F, a proximity sensor 1040G, a color sensor 1040H (e.g., a Red-Green-Blue (RGB) sensor), a biometric sensor 1040I, a temperature/humidity sensor 1040J, an illuminance sensor 1040K, and an Ultraviolet (UV) sensor 1040M. Additionally or alternatively, the sensor module 1040 may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 1040 may further include a control circuit for controlling one or more sensors included therein. In some embodiments of the present disclosure, the electronic device 1001 may further include a processor configured to control the sensor module 1040 as a part of or separately from the processor 1010, and may control the sensor module 1040 while the processor 1010 is in a sleep state.

The input apparatus 1050 may include various input circuitry, such as, for example, and without limitation, a touch panel 1052, a (digital) pen sensor 1054, a key 1056, and an ultrasonic input unit 1058. The touch panel 1052 may use at least one of, for example, a capacitive scheme, a resistive scheme, an infrared scheme, and an acoustic wave scheme. Also, the touch panel 1052 may further include a control circuit. The touch panel 1052 may further include a tactile layer and may provide a tactile response to the user. The (digital) pen sensor 1054 may include, for example, a recognition sheet which is a part of the touch panel or is separated from the touch panel. The key 1056 may be, for example, a physical button, an optical key, and a keypad. The ultrasonic input unit 1058 may sense an ultrasonic wave generated by an input means through a microphone (e.g., a microphone 1088), and may confirm data corresponding to the sensed ultrasonic wave.

The display 1060 (e.g., the display 960) may include a panel 1062, a hologram unit 1064, a projector 1066, and/or a control circuit for controlling the same. The panel 1062 may be implemented to be, for example, flexible, transparent, or wearable. The panel 1062 and the touch panel 1052 may be implemented as one or more modules. According to an embodiment of the present disclosure, the panel 1062 may include a pressure sensor (or a force sensor) capable of measuring the strength of pressure of a user's touch. The pressure sensor and the touch panel 1052 may be integrated into one unit, or the pressure sensor may be implemented by one or more sensors separated from the touch panel 1052. The hologram unit 1064 may display a three-dimensional image in the air by using the interference of light. The projector 1066 may display an image by projecting light onto a screen. The screen may be located, for example, inside or outside the electronic device 1001. The interface 1070 may include various interface circuitry, such as, for example, and without limitation, a High-Definition Multimedia Interface (HDMI) 1072, a Universal Serial Bus (USB) 1074, an optical interface 1076, and a D-subminiature (D-sub) 1078. The interface 1070 may be included in, for example, the communication interface 970 illustrated in FIG. 9. Additionally or alternatively, the interface 1070 may include, for example, a Mobile High-definition Link (MHL) interface, a Secure Digital (SD) card/Multi-Media Card (MMC) interface, or an Infrared Data Association (IrDA) standard interface.

For example, the audio module 1080 may bidirectionally convert between a sound and an electrical signal. At least some elements of the audio module 1080 may be included in, for example, the input/output interface 950 illustrated in FIG. 9. The audio module 1080 may process sound information which is input or output through, for example, a speaker 1082, a receiver 1084, an earphone 1086, the microphone 1088, or the like.

The camera module 1091 is, for example, a device capable of capturing a still image and a moving image. According to an embodiment of the present disclosure, the camera module 1091 may include one or more image sensors (e.g., a front sensor or a back sensor), a lens, an Image Signal Processor (ISP), and a flash (e.g., an LED, a xenon lamp, or the like). The power management module 1095 may manage, for example, power of the electronic device 1001. According to an embodiment of the present disclosure, the power management module 1095 may include a Power Management Integrated Circuit (PMIC), a charger IC, or a battery fuel gauge. The PMIC may use a wired and/or wireless charging method. Examples of the wireless charging method may include, for example, a magnetic resonance method, a magnetic induction method, an electromagnetic method, and the like. Additional circuits (e.g., a coil loop, a resonance circuit, a rectifier, etc.) for wireless charging may be further included. The battery fuel gauge may measure, for example, a residual quantity of the battery 1096, and a voltage, a current, or a temperature during the charging. The battery 1096 may include, for example, a rechargeable battery and/or a solar battery.

The indicator 1097 may display a particular state (e.g., a booting state, a message state, a charging state, or the like) of the electronic device 1001 or a part (e.g., the processor 1010) of the electronic device 1001. The motor 1098 may convert an electrical signal into a mechanical vibration, and may generate a vibration, a haptic effect, or the like. The electronic device 1001 may include a mobile television (TV) support unit (e.g., a GPU) that may process media data according to a standard, such as, for example, Digital Multimedia Broadcasting (DMB), Digital Video Broadcasting (DVB), or mediaFLO™. Each of the above-described elements of hardware according to the present disclosure may be configured with one or more components, and the names of the corresponding elements may vary based on the type of electronic device. In various embodiments of the present disclosure, the electronic device (e.g., the electronic device 1001) may omit some elements or may further include additional elements, or some of the elements of the electronic device may be combined into one entity, which may perform functions identical to those of the relevant elements before the combination.

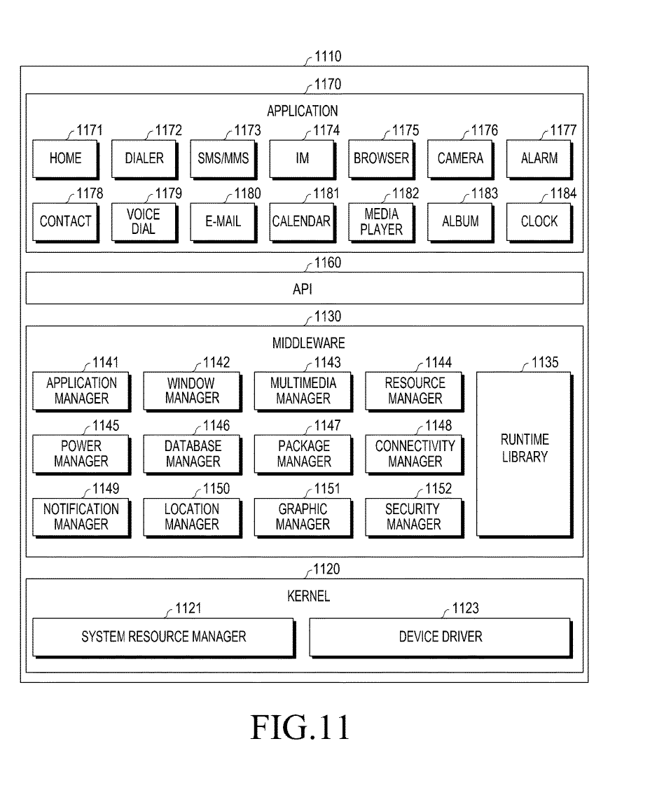

FIG. 11 is a block diagram illustrating an example of a configuration of a program module according to various example embodiments of the present disclosure.

According to various embodiments of the present disclosure, the program module 1110 (e.g., the program 940) may include an OS for controlling resources related to the electronic device (e.g., the electronic device 901) and/or various applications (e.g., the application programs 947) executed in the OS. The OS may be, for example, Android™, iOS™, Windows™, Symbian™, Tizen™, Bada™, and the like.

Referring to FIG. 11, the program module 1110 may include a kernel 1120 (e.g., the kernel 941), middleware 1130 (e.g., the middleware 943), an API 1160 (e.g., the API 945), and/or an application 1170 (e.g., the application program 947). At least some of the program module 1110 may be preloaded on the electronic device, or may be downloaded from an external electronic device (e.g., the electronic device 902 or 904, or the server 906).

The kernel 1120 may include, for example, a system resource manager 1121 and/or a device driver 1123. The system resource manager 1121 may control, allocate, or retrieve system resources. According to an embodiment of the present disclosure, the system resource manager 1121 may include a process manager, a memory manager, or a file system manager. The device driver 1123 may include, for example, a display driver, a camera driver, a Bluetooth driver, a shared memory driver, a USB driver, a keypad driver, a Wi-Fi driver, an audio driver, or an Inter-Process Communication (IPC) driver. For example, the middleware 1130 may provide a function required in common by the applications 1170, or may provide various functions to the applications 1170 through the API 1160 so as to enable the applications 1170 to use the limited system resources within the electronic device. According to an embodiment of the present disclosure, the middleware 1130 may include at least one of a runtime library 1135, an application manager 1141, a window manager 1142, a multimedia manager 1143, a resource manager 1144, a power manager 1145, a database manager 1146, a package manager 1147, a connectivity manager 1148, a notification manager 1149, a location manager 1150, a graphic manager 1151, and a security manager 1152.

The runtime library 1135 may include, for example, a library module that a complier uses to add a new function by using a programming language during the execution of the application 1170. The runtime library 1135 may manage input/output, manage a memory, or process an arithmetic function. The application manager 1141 may manage, for example, the life cycle of the application 1170. The window manager 1142 may manage Graphical User Interface (GUI) resources used for the screen. The multimedia manager 1143 may determine formats required to reproduce media files, and may encode or decode a media file by using a coder/decoder (codec) appropriate for the relevant format. The resource manager 1144 may manage a source code of the application 1170 or a memory space for the application 1170. For example, the power manager 1145 may manage the capacity of a battery or power, and may provide power information required for an operation of the electronic device. According to an embodiment of the present disclosure, the power manager 1145 may operate in conjunction with a Basic Input/Output System (BIOS). The database manager 1146 may, for example, generate, search, or change a database to be used by the application 1170. The package manager 1147 may manage the installation or update of an application distributed in the form of a package file.

For example, the connectivity manager 1148 may manage a wireless connection. The notification manager 1149 may display or notify of an event, such as an arrival message, an appointment, a proximity notification, and the like. For example, the location manager 1150 may manage location information of the electronic device. For example, the graphic manager 1151 may manage a graphic effect, which is to be provided to the user, or a user interface related to the graphic effect. For example, the security manager 1152 may provide system security or user authentication. According to an embodiment of the present disclosure, the middleware 1130 may include a telephony manager for managing a voice call function or a video call function of the electronic device, or may include a middleware module capable of forming a combination of functions of the above-described elements.

According to an embodiment of the present disclosure, the middleware 1130 may provide a module specialized for each type of OS. The middleware 1130 may dynamically delete some of the existing elements, or may add new elements. The API 1160 is, for example, a set of API programming functions, and may be provided with a different configuration according to an OS. For example, in the case of Android or iOS, one API set may be provided for each platform. In the case of Tizen, two or more API sets may be provided for each platform.

The application 1170 may include, for example, a home 1171, a dialer 1172, an SMS/MMS 1173, an Instant Message (IM) 1174, a browser 1175, a camera 1176, an alarm 1177, a contact 1178, a voice dialer 1179, an email 1180, a calendar 1181, a media player 1182, an album 1183, a clock 1184, health care (e.g., which measures an exercise quantity, a blood sugar level, or the like), and an application for providing environmental information (e.g., information on atmospheric pressure, humidity, or temperature). According to an embodiment of the present disclosure, the application 1170 may include an information exchange application capable of supporting information exchange between the electronic device and an external electronic device. The information exchange application may include, for example, a notification relay application for delivering particular information to an external electronic device or a device management application for managing an external electronic device. For example, the notification relay application may deliver, to the external electronic device, notification information generated by the other applications of the electronic device, or may receive notification information from the external electronic device and may provide the received notification information to the user. The device management application may install, delete, or update, for example, a function (e.g., turning on/off the external electronic device itself (or some elements thereof) or adjusting the brightness (or resolution) of the display) of the external electronic device communicating with the electronic device, or an application executed in the external electronic device. According to an embodiment of the present disclosure, the application 1170 may include an application (e.g., a health care application of a mobile medical device) designated according to an attribute of the external electronic device. According to an embodiment of the present disclosure, the application 1170 may include an application received from the external electronic device. At least part of the program module 1110 may be implemented (e.g., executed) in software, firmware, hardware (e.g., the processor 1010), or at least two combinations thereof, and may include a module, a program, a routine, a set of instructions, or a process for performing one or more functions.

The term “module” as used herein may refer to a unit including hardware (e.g., circuitry), software, or firmware, and for example, may be used interchangeably with a term, such as a logic, a logical block, a component, or a circuit. The “module” may be an integrated component, or a minimum unit for performing one or more functions or a part thereof. The “module” may be mechanically or electronically implemented, and may include, for example, and without limitation, processing circuitry, an Application-Specific Integrated Circuit (ASIC) chip, a Field-Programmable Gate Array (FPGA), or a programmable-logic device which performs certain operations and has been known or is to be developed in the future. At least part of the device (e.g., modules or functions thereof) or the method (e.g., operations) according to various embodiments of the present disclosure may be implemented by an instruction stored in a computer-readable storage medium (e.g., the memory 930) provided in the form of a program module. When the instruction is executed by a processor (e.g., the processor 920), the processor may perform a function corresponding to the instruction. The computer-readable recoding medium may include magnetic media, such as a hard disk, a floppy disk, and a magnetic tape; optical media, such as a Compact Disc Read Only Memory (CD-ROM) and a Digital Versatile Disc (DVD); magneto-optical media, such as a floptical disk; an internal memory; and the like. The instructions may include codes made by a compiler and/or codes which can be executed by an interpreter.

The module or program module according to various embodiments of the present disclosure may include at least one of the aforementioned elements, may further include other elements, or some of the aforementioned elements may be omitted. Operations executed by the module, program module, or other elements according to various embodiments of the present disclosure may be executed sequentially, in parallel, repeatedly, or in a heuristic manner. Also, at least some operations may be executed in a different order or may be omitted, or other operations may be added.

Example embodiments of the present disclosure are provided to describe technical contents of the present disclosure and to aid in understanding of the present disclosure, and are not intended to limit the scope of the present disclosure. Therefore, it should be understood that all modifications and changes or various other embodiments which are based on the technical idea of the present disclosure fall within the scope of the present disclosure.

What is claimed is:

1. An electronic device comprising:
image acquisition circuitry; and
a processor comprising processing circuitry,
wherein the processor is configured:
to determine information related to at least one image frame acquired by the image acquisition circuitry in response to determining a recording start command,
to select at least one image frame from the acquired at least one image frame based on the determined information, and
in response to determining a recording end command corresponding to the recording start command, to generate a video including the selected at least one image frame.

2. The electronic device as claimed in claim 1, wherein the processor is configured to determine an average importance of the generated video based on importance values of the acquired at least image frame, and to reset timestamp values of the selected at least one image frame which are acquired during each of predetermined time periods when the average importance is determined as being a value in a predetermined range and
wherein the determined information includes the importance values of the acquired at least image frame.

3. The electronic device as claimed in claim 2, wherein the processor is configured to set a reproduction time interval between the selected at least one image frame having the reset timestamps based on the importance values of the respective image frames.

4. The electronic device as claimed in claim 3, wherein the processor is configured:
to determine the selected at least one image frame based on the set timestamp values in response to determining a reproduction start command, and
to reproduce the selected at least one image frame at the set reproduction time interval.

5. The electronic device as claimed in claim 1, further comprising input/output circuitry,
wherein the processor is configured:
to determine an audio data corresponding to a timestamp value of a particular image frame among audio data which are input through the input/output circuitry, and
to generate the video by combining each of the selected at least one image frame with the determined audio data.

6. The electronic device as claimed in claim 5, wherein the processor is configured to determine importance values of the acquired at least one image frame based on at least part of information of the audio data and the determined information,
wherein the information of the audio data comprises at least one information from among volume information and an audio type information and
wherein the determined information comprises at least one information from among object information on an object image-captured in the relevant image frame and image-capturing quality information.

7. The electronic device as claimed in claim 6, further comprising a sensor module comprising at least one sensor,
wherein the processor is configured:
to determine sensor data corresponding to a timestamp value of particular visual data from among sensor data which are received from the sensor module, and
to determine the importance values of each of the acquired at least one image frame based on the determined sensor data and
wherein the determined information includes the sensor data received from the sensor module.

8. The electronic device as claimed in claim 6, wherein the processor is configured:
to determine an importance value of the image data to be greater than or equal to a predetermined value, when the volume of the information of the audio data is determined as a value in a predetermined range and
determine an importance value of the image data to be greater than or equal to a predetermined value, when the audio type of the information of the audio data corresponds to a predetermined type.

9. The electronic device as claimed in claim 6, wherein the processor is configured:
to determine a size or resolution of the object image-captured in the acquired at least one image frame based on the image-captured object information, and
to determine an importance value of the image data to be greater than or equal to a predetermined value, when the object image-captured in the image frame is image-captured to be greater than or equal to a predetermined size or a predetermined resolution.

10. The electronic device as claimed in claim 6, wherein the processor is configured:
to determine identification information of the object image-captured in the image frame, and
to determine an importance value of the image data to be greater than or equal to a predetermined value, when the image-captured object represents a predetermined user or a predetermined target corresponding to the identification information.

11. A video recording method of an electronic device, the video recording method comprising:
determining information related to at least one image frame acquired by image acquisition circuitry in response to determining a recording start command;
selecting at least one image frame from the acquired at least one image frame based on the determined information; and
in response to determining a recording end command corresponding to the recording start command, generating a video including the selected at least one image frame.

12. The video recording method as claimed in claim 11, further comprising:
determining an average importance value of the generated video based on importance values of the acquired at least image frame; and
resetting timestamp values of the selected at least one image frame which are acquired during each of predetermined time periods when the average importance value is determined to be a value in a predetermined range and wherein the determined information includes the importance values of the acquired at least image frame.

13. The video recording method as claimed in claim 12, further comprising setting a reproduction time interval between the selected at least one image frame having the reset timestamps based on the importance values of the respective image frames.

14. The video recording method as claimed in claim 13, further comprising:
determining the selected at least one image frame based on the set timestamp values in response to determining a reproduction start command; and
reproducing the selected at least one image frame at the set reproduction time interval.

15. The video recording method as claimed in claim 11, further comprising:
determining an audio data corresponding to a timestamp value of a particular image frame among audio data which are received through an input/output module; and
generating the video by combining each of the selected at least one image frame with the determined audio data.

16. The video recording method as claimed in claim 15, further comprising determining importance values of the acquired at least one image frame based on at least part of information of the audio data and information of the image frames,
wherein the information of the audio data comprises at least one information from among volume information and an audio type information and wherein the determined information comprises at least one information from among object information on an object image-captured in the relevant image frame and image-capturing quality information.

17. The video recording method as claimed in claim 16, further comprising:
determining sensor data corresponding to a timestamp value of particular visual data among sensor data which are received from a sensor module; and
determining the importance values of each of the acquired at least one image frame based on the determined sensor data,
wherein the determined information includes the sensor data received from the sensor module.

18. The video recording method as claimed in claim 16, further comprising:
determining an importance value of the image data to be greater than or equal to a predetermined value, when the volume of the information of the audio data is determined as a value in a predetermined range and
determining an importance value of the image data to be greater than or equal to a predetermined value, when the audio type of the information of the audio data corresponds to a predetermined type.

19. The video recording method as claimed in claim 16, further comprising:
determining a size or resolution of the object image-captured in the acquired at least one image frame based on the image-captured object information; and
determining an importance value of the image data to be greater than or equal to a predetermined value, when the object image-captured in the image frame is image-captured to be greater than or equal to a predetermined size or a predetermined resolution.

20. The video recording method as claimed in claim 16, further comprising:
further determining identification information of the object image-captured in the image frame; and
determining an importance value of the image data to be greater than or equal to a predetermined value, when the image-captured object represents a predetermined user or a predetermined target corresponding to the identification information.
